(19) United States
(12) Patent Application Publication
(10) Pub. No.: US 2026/0088200 A1
(43) Pub. Date: Mar. 26, 2026

(54) Thermally Protected Metal Oxide Varistor with Indicator Circuit

(71) Applicant: Dongguan Littelfuse Electronics Company Limited, Dongguan City (CN)

(72) Inventors: Hailang Tang, GuangDong (CN); Yanjing Xiao, Dongguan City (CN); Ben Zheng, Bremen (DE)

(73) Assignee: Dongguan Littelfuse Electronics Company Limited, Dongguan City (CN)

(21) Appl. No.: 19/336,674

(22) Filed: Sep. 23, 2025

(30) Foreign Application Priority Data
Sep. 26, 2024 (CN) 202411354075.X

(51) Int. Cl. H01C 7/12; H01C 1/148

(52) U.S. Cl. CPC H01C 7/126; H01C 1/148

(57) ABSTRACT

A thermal protection device may include a varistor body within a housing, the varistor body comprising a thermal electrode disposed along a first side. The thermal protection device may further include a first terminal connected to the first side and a second terminal connected to a second side of the thermal electrode. The thermal protection device may further include an indicator circuit comprising a first pin and a second pin disposed along the first side of the varistor body, wherein the second pin is connected to a slider, wherein a thermal event causes movement of the slider between a first position and a second position, and wherein when the slider is in the second position, the first pin and the second pin separate from one another.

### CROSS-REFERENCE TO RELATED APPLICATIONS

This application claims the benefit of priority to, Chinese Patent Application No. 202411354075.X, filed September 26, 2024, entitled “THERMALLY PROTECTED METAL OXIDE VARISTOR WITH INDICATOR CIRCUIT,” which application is incorporated herein by reference in its entirety.

### FIELD OF THE DISCLOSURE

The disclosure relates generally to the protection of electrical and electronic circuits and equipment from power surges and, more particularly, to a thermally protected metal oxide varistor including an indicator circuit.

### BACKGROUND OF THE DISCLOSURE

Over-voltage protection devices are used to protect electronic circuits and components from damage due to over-voltage fault conditions. These over-voltage protection devices may include metal oxide varistors (MOVs) that are connected between the circuits to be protected, and a ground line. MOVs have a specific current-voltage characteristic that allows them to be used to protect such circuits against catastrophic voltage surges. Typically, these devices utilize spring elements and linking materials, which can melt during an abnormal condition to form an open circuit. In particular, when a voltage that is larger than the nominal or threshold voltage is applied to the device, current flows through an MOV, which generates heat. This causes the linking element to melt. Once the link melts, an open circuit is created, which prevents the MOV from catching fire.

Although thermally protected varistors are presently available, the currently available thermal disconnect varistors comprise complicated assemblies and are costly to manufacture. Another drawback of known approaches of thermally protected varistors is that they are one-time use components that must be replaced once the thermal disconnect has been triggered. As the thermal disconnect is typically enclosed in a casing, an individual maintaining the equipment may be unable to easily determine when the thermal disconnect has been triggered and needs to be replaced.

Thus, there presently exists a need for an efficiently constructed varistor for protecting sensitive electrical circuits and equipment from abnormal overvoltage transients that can be easily maintained and serviced. It is with respect to these and other considerations that the present improvements are provided.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In some embodiments, a thermal protection device may include a varistor body within a housing, the varistor body comprising a thermal electrode disposed along a first side. The thermal protection device may further include a first terminal connected to the first side and a second terminal connected to a second side of the thermal electrode. The thermal protection device may further include an indicator circuit comprising a first pin and a second pin disposed along the first side of the varistor body, wherein the second pin is connected to a slider, wherein a thermal event causes movement of the slider between a first position and a second position, and wherein when the slider is in the second position, the first pin and the second pin separate from one another.

In some embodiments, a metal oxide varistor (MOV) device may include a varistor body within a housing, the varistor body comprising a thermal electrode disposed along a first side, and a first terminal connected to the first side and a second terminal connected to a second side of the thermal electrode. The MOV device may further include an indicator circuit comprising a first pin and a second pin disposed along the first side of the varistor body, wherein the second pin is connected to a slider, wherein a thermal event causes a disconnection between the first terminal and the thermal electrode, wherein the disconnection between the first terminal and the thermal electrode causes movement of the slider between a first position and a second position, and wherein when the slider is in the second position, the first pin and the second pin separate from one another.

In some embodiments, a thermal metal oxide varistor (TMOV) device may include a varistor body within a housing, the varistor body comprising a thermal electrode disposed along a first side, and a first terminal connected to the first side and a second terminal connected to a second side of the thermal electrode. The TMOV may further include an indicator circuit comprising a first pin and a second pin disposed along an inner wall of the housing, wherein the second pin is connected to a slider, wherein a thermal event causes a disconnection between the first terminal and the thermal electrode, wherein the disconnection between the first terminal and the thermal electrode causes movement of the slider along the inner wall, between a first position and a second position, and wherein when the slider is in the second position, the first pin and the second pin separate from one another.

### BRIEF DESCRIPTION OF THE DRAWINGS

The accompanying drawings illustrate exemplary approaches of the disclosed embodiments so far devised for the practical application of the principles thereof, and in which:

FIG. 1 depicts a circuit diagram including an MOV device according to embodiments of the present disclosure;

FIG. 2 is a top perspective view of an MOV device according to embodiment of the present disclosure;

FIG. 3 is a cutaway view of an MOV device according to embodiment of the present disclosure;

FIG. 4 is a top perspective view of an MOV device according to embodiment of the present disclosure;

FIG. 5 is a top perspective view of an MOV device according to embodiment of the present disclosure;

FIG. 6 is a top perspective view of an MOV device according to embodiment of the present disclosure;

FIG. 7 is a close-up perspective view of a terminal connection of an MOV device according to embodiment of the present disclosure; and

FIG. 8 is a bottom perspective view of an MOV device according to embodiment of the present disclosure.

The drawings are not necessarily to scale. The drawings are merely representations, not intended to portray specific parameters of the disclosure. The drawings are intended to depict typical embodiments of the disclosure, and therefore should not be considered as limiting in scope. In the drawings, like numbering represents like elements.

Furthermore, certain elements in some of the figures may be omitted, or illustrated not-to-scale, for illustrative clarity. Cross-sectional views may be in the form of "slices", or "near-sighted" cross-sectional views, omitting certain background lines otherwise visible in a "true" cross-sectional view, for illustrative clarity. Furthermore, for clarity, some reference numbers may be omitted in certain drawings.

### DETAILED DESCRIPTION

Protection devices in accordance with the present disclosure will now be described more fully hereinafter with reference to the accompanying drawings, in which embodiments of the system and method are shown. The protection devices, however, may be embodied in many different forms and should not be construed as being limited to the embodiments set forth herein. Rather, these embodiments are provided so that this disclosure will be thorough and complete, and will fully convey the scope of the system and method to those skilled in the art.

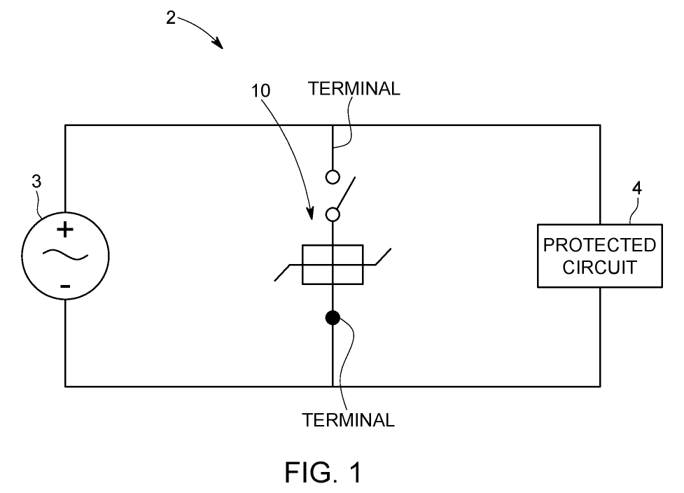

Turning now to FIG. 1, a thermally protected varistor (TPV) device 10 for use with an electrical circuit 2 according to embodiments of the disclosure will be described. The TPV device 10 may be a TMOV. The simplified electrical circuit 2 generally comprises the TPV device 10, a power source 3, and a protected electrical circuit or equipment 4. As will be understood by those skilled in the art, during normal operation, the TPV device 10, which may be positioned in parallel between a first terminal of the power source 3 and the protected electrical circuit 4, is in a closed, or conducting, position, and the protected electrical circuit 4 is powered by the power source 3. As will be described below, in an overvoltage situation, the TPV device 10 opens. The electrical circuit 2 described herein is not intended to be limiting, but merely provides an illustrative example of a general electrical circuit for context.

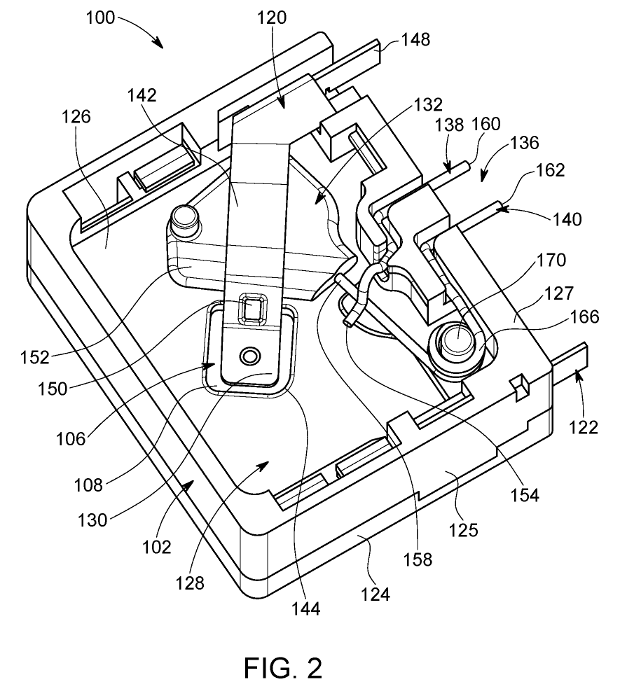

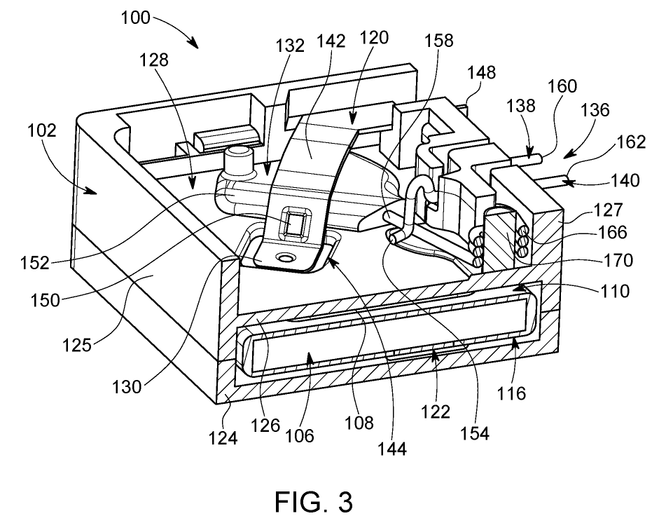

Turning now to FIGS. 2-4, a MOV device (hereinafter “device”) 100 according to embodiments of the disclosure will be described in greater detail. The device 100 may be the same or similar to TPV device 10 described above. As shown, the device 100 may include a housing 102 containing varistor body 106, which in this embodiment has a rectangular or cuboid shape. The varistor body 106 may include a thermal electrode 108 disposed along a first side 110, and an electrode (not shown) disposed along a second side 116. A first terminal 120 is electrically connected to the thermal electrode 108, while a second terminal 122 is electrically connected to the electrode, along the second side 116 of the varistor body 106. In some embodiments, the thermal electrode 108 is a metallization layer of ceramic, silver, copper, aluminum, or copper plus aluminum.

The housing 102 may include a base 124 and a central section 125, wherein the central section 125 includes an inner wall 126 extending between perimeter walls 127. Although not shown, the housing 102 may include a top cover. The inner wall 126 and the perimeter walls 127 define an interior 128 of the housing 102. Within the interior 128 is a first end 130 of the first terminal 120, positioned adjacent to a slider 132. As will be described in greater detail herein, the slider 132 may be positioned atop/adjacent the inner wall 126, and may be connected to an indicator circuit 136 including a first pin 138 and a second pin 140.

In some embodiments, the first terminal 120 may include a spring body 142 extending over the slider 132, the spring body 142 located between the first end 130 and a second end 148 of the first terminal 120. The first end 130 of the first terminal 120 may extend through an opening 144 of the inner wall 126, and may be connected to the thermal electrode 108 by a thermal linking element (e.g., solder). Should the thermal linking element exceed a melting point, for example in the event of an over-current condition, the spring body 142 will detach and move away from the thermal electrode 108 exposed through the opening 144, thus causing disconnection from the power supply. Before being heated, the thermal linking element prevents the free end 130 from moving away from the thermal electrode 108, and thus also prevents the slider 132 from rotating towards the opening 144. In some embodiments, the first terminal 120 may include a protrusion 150 operable to engage a body 152 of the slider 132.

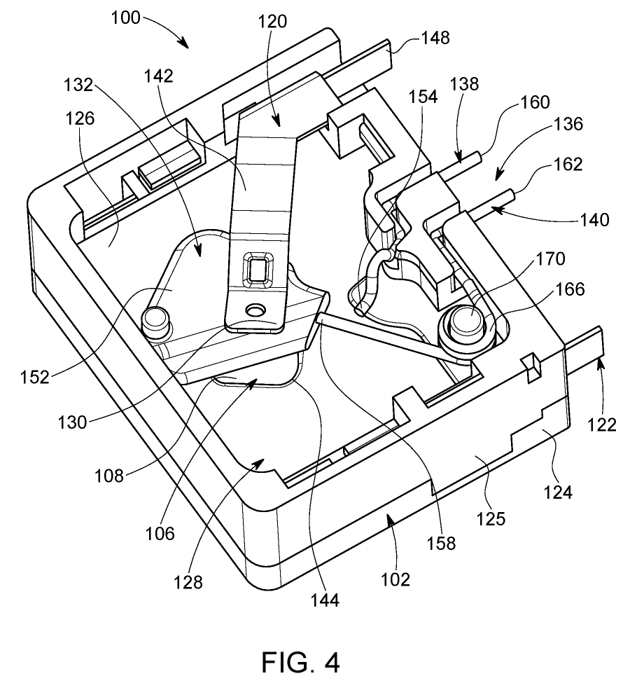

The indicator circuit 136 is operable to provide an indication of the open/closed status of the first terminal 120 with the thermal electrode 108. That is, in a first position of the slider 132, as shown in FIGS. 2 – 3, the first pin 138 and the second pin 140 are in direct physical and electrical contact with one another. When the slider 132 is in a second position, i.e., when the slider 132 rotates towards the opening 144, as shown in FIG. 4, the first pin 138 and the second pin 140 separate from one another. This disconnection between the first and second pins 138, 140 causes a change in a status signal. As shown, the second pin 140 is directly coupled to the slider 132, and a first end 154 of the first pin 138 is operable to engage/disengage a first end 158 of the second pin 140. A second end 160 of the first pin 138 and a second end 162 of the second pin 140 extend outside of the housing 102. In some embodiments, the second pin 140 may include a coiled section 166 wrapped around a support post 170 of the housing 102, causing the second pin 140 to operate as a torsion spring. More specifically, the second pin 140 may include an “L” shaped first portion connected to one of the perimeter walls 127, while the first end 158 may extend within the body 152 of the slider 132. The second pin 140 thus provides a force against the spring body 142 of the first terminal 120 via the slider 132.

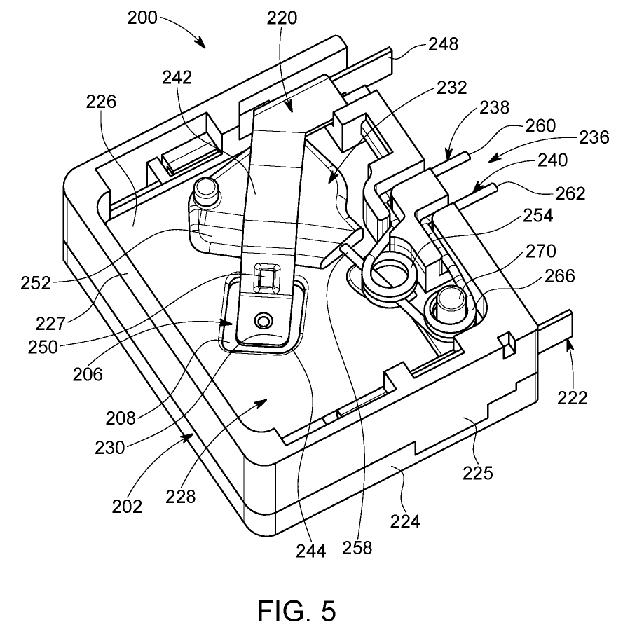

FIGS. 5 - 6 demonstrate another MOV device (hereinafter “device”) 200 according to embodiments of the disclosure will be described in greater detail. The device 200 may be the same or similar to the device 100 described above. As such, only certain aspects of the device 200 will hereinafter be described for the sake of brevity. As shown, the device 200 may include a housing 202 containing varistor body 206, which may include a thermal electrode 208 disposed along a first side, and an electrode (not shown) disposed along a second side. A first terminal 220 is electrically connected to the thermal electrode 208, while a second terminal 222 is electrically connected to the electrode, along the second side of the varistor body 206. In some embodiments, the thermal electrode 208 is a metallization layer of ceramic, silver, copper, aluminum, or copper plus aluminum.

The housing 202 may include a base 224 and a central section 225, wherein the central section 225 includes an inner wall 226 extending between perimeter walls 227. Although not shown, the housing 202 may include a top cover. The inner wall 226 and the perimeter walls 227 define an interior 228 of the housing 202. Within the interior 228 is a first end 230 of the first terminal 220, positioned adjacent to a slider 232. The slider 232 may be positioned atop/adjacent the inner wall 226, and may be connected to an indicator circuit 236 including a first pin 238 and a second pin 240.

In some embodiments, the first terminal 220 may include a spring body 242 extending over the slider 232, the spring body 242 located between the first end 230 and a second end 248 of the first terminal 220. The first end 230 of the first terminal 220 may extend through an opening 244 of the inner wall 226, and may be connected to the thermal electrode 208 by a thermal linking element (e.g., solder). Should the thermal linking element exceed a melting point, for example in the event of an over-current condition, the spring body 242 will detach and move away from the thermal electrode 208 exposed through the opening 244, thus causing disconnection from the power supply. Before being heated, the thermal linking element prevents the free end 230 from moving away from the thermal electrode 208, and thus also prevents the slider 232 from rotating towards the opening 244. In some embodiments, the first terminal 220 may include a protrusion 250 operable to engage a body 252 of the slider 232.

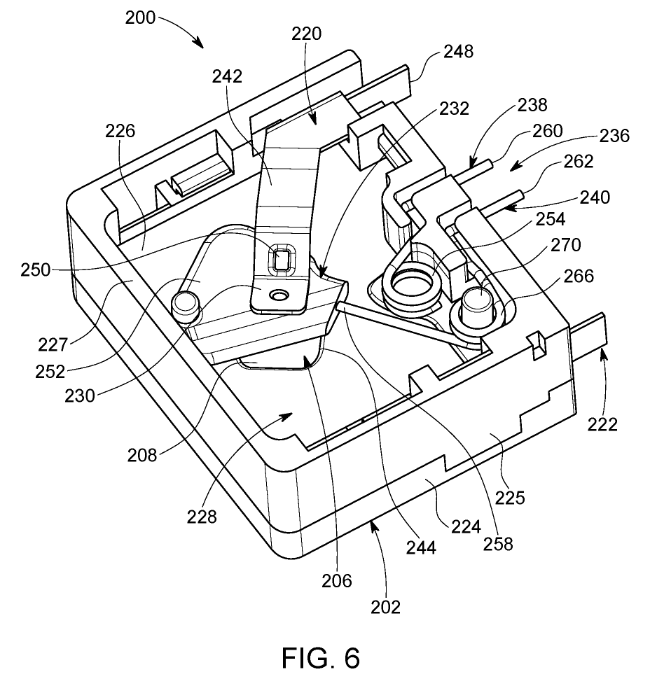

The indicator circuit 236 is operable to provide an indication of the open/closed status of the first terminal 220 with the thermal electrode 208. That is, in a first position of the slider 232, as demonstrated in FIG. 5, the first pin 238 and the second pin 240 are in direct physical and electrical contact with one another. When the slider 232 is in a second position, i.e., when the slider 232 rotates towards the opening 244, as shown in FIG. 6, the first pin 238 and the second pin 240 separate from one another. This disconnection between the first and second pins 238, 240 causes a change in a status signal. As shown, the second pin 240 is directly coupled to the slider 232, and a first end 254 of the first pin 238 is operable to engage/disengage a first end 258 of the second pin 240. More specifically, the first end 254 of the first pin 238 may include a coiled section 261, wherein the second pin 260 is sandwiched between adjacent coil elements of the coiled section 261 when the slider 232 is in the first position. A second end 260 of the first pin 238 and a second end 262 of the second pin 240 extend outside of the housing 202. In some embodiments, the second pin 240 may include a coiled section 266 wrapped around a support post 270 of the housing 202, causing the second pin 240 to operate as a torsion spring, which provides a force against the spring body 242 of the first terminal 220 via the slider 232.

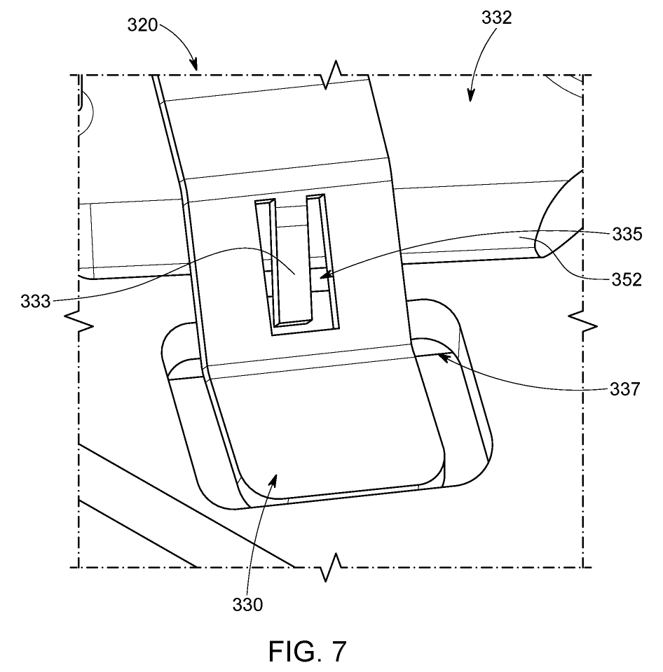

FIG. 7 demonstrates an example first end 330 of a first terminal 320 according to an embodiment of the disclosure. In this embodiment, the first end 330 may include a retention member 333 within a central opening 335. The retention member 333 may extend towards an opening 344 of a housing 302, and may be operable to engage a body 352 of a slider 332. The retention member 333 may be a rib or finger which helps reduce the stress from the slider 332 on a solder joint 337, and helps to raise the first terminal 320 when thermal disconnection occurs. The retention member 333 may be included as part of the first terminals 120 and 220 described herein.

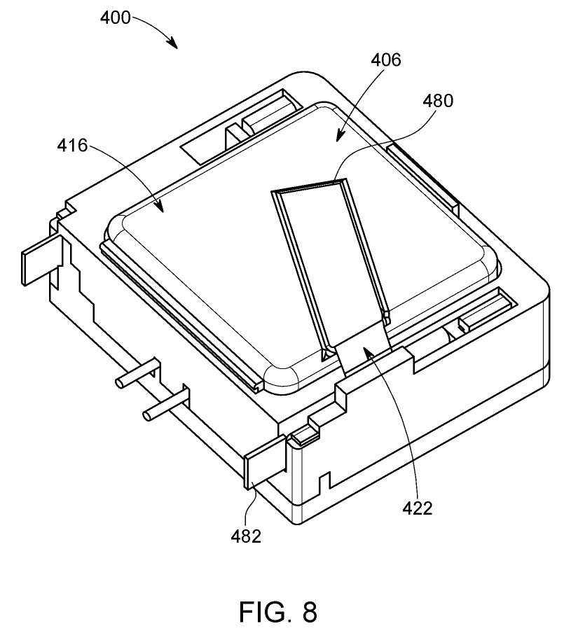

FIG. 8 demonstrates a backside of an example device 400 according to embodiments of the disclosure. As shown, a varistor body 406 may include a second terminal 422 disposed along a second side 416 of the varistor body 406. That is, a first end 480 of the second terminal 422 may extend along an electrode of the varistor body 406, while a second end 482 of the second terminal 422 may extend outside of a housing 402 of the device. The device 400 may be the same or similar to the devices 100, 200, and 300 described above.

In sum, embodiments described herein provide at least the following benefits. Firstly, an indicator function is mechanical linked with a thermal disconnector, and provides a reliable/accurate signal output. Secondly, the devices are compact, equipped with simplified micro-switch/indicator design, which saves space in end customer application. Thirdly, fast, robust, and reliable design on thermal disconnection mechanism helps safety survive (cut-off main circuit current), e.g., under 200kA sscr testing.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose. Those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

1. A thermal protection device, comprising:
a varistor body within a housing, the varistor body comprising a thermal electrode disposed along a first side;
a first terminal connected to the first side and a second terminal connected to a second side of the thermal electrode; and
an indicator circuit comprising a first pin and a second pin disposed along the first side of the varistor body, wherein the second pin is connected to a slider, wherein a thermal event causes movement of the slider between a first position and a second position, and wherein when the slider is in the second position, the first pin and the second pin separate from one another.

2. The thermal protection device of claim 1, wherein the housing comprises an inner wall, wherein the inner wall comprises an opening, and wherein a first end of the first terminal extends through the opening when the slider is in the first position.

3. The thermal protection device of claim 2, wherein the first end of the first terminal comprises a protrusion operable to engage a body of the slider.

4. The thermal protection device of claim 1, wherein the second pin is a torsion spring coupled to a perimeter wall of the housing.

5. The thermal protection device of claim 1, wherein the first pin comprises a first end extending into an interior of the housing, and wherein the first end is in direct contact with the second pin when the slider is in the first position.

6. The thermal protection device of claim 5, wherein the first end of the first pin comprises a coiled section.

7. The thermal protection device of claim 1, wherein the second pin comprises a coiled section wrapped around a support of the housing.

8. The thermal protection device of claim 1, wherein the first terminal comprises a spring body extending over the slider.

9. The thermal protection device of claim 1, wherein the first terminal is connected to the thermal electrode by a thermal linking material.

10. A metal oxide varistor (MOV) device, comprising:
a varistor body within a housing, the varistor body comprising a thermal electrode disposed along a first side;
a first terminal connected to the first side and a second terminal connected to a second side of the thermal electrode; and
an indicator circuit comprising a first pin and a second pin disposed along the first side of the varistor body, wherein the second pin is connected to a slider, wherein a thermal event causes a disconnection between the first terminal and the thermal electrode, wherein the disconnection between the first terminal and the thermal electrode causes movement of the slider between a first position and a second position, and wherein when the slider is in the second position, the first pin and the second pin separate from one another.

11. The MOV device of claim 10, wherein the housing comprises an inner wall, wherein the inner wall comprises an opening, and wherein a first end of the first terminal extends through the opening when the slider is in the first position.

12. The MOV device of claim 11, wherein the first end of the first terminal comprises a protrusion operable to engage a body of the slider.

13. The MOV device of claim 10, wherein the second pin is a torsion spring coupled to a perimeter wall of the housing.

14. The MOV device of claim 10, wherein the first pin comprises a first end extending into an interior of the housing, and wherein the first end is in direct contact with the second pin when the slider is in the first position.

15. The MOV device of claim 14, wherein the first end of the first pin comprises a coiled section, and wherein the second pin is located between two adjacent coil elements of the coiled section when the slider is in the first position.

16. The MOV device of claim 10, wherein the second pin comprises a coil wrapped around a support of the housing.

17. The MOV device of claim 10, wherein the first terminal comprises a spring body extending over the slider.

18. A thermal metal oxide varistor (TMOV) device, comprising:
a varistor body within a housing, the varistor body comprising a thermal electrode disposed along a first side;
a first terminal connected to the first side and a second terminal connected to a second side of the thermal electrode; and
an indicator circuit comprising a first pin and a second pin disposed along an inner wall of the housing, wherein the second pin is connected to a slider, wherein a thermal event causes a disconnection between the first terminal and the thermal electrode, wherein the disconnection between the first terminal and the thermal electrode causes movement of the slider along the inner wall, between a first position and a second position, and wherein when the slider is in the second position, the first pin and the second pin separate from one another.

19. The TMOV device of claim 18, wherein the inner wall comprises an opening, and wherein a first end of the first terminal extends through the opening when the slider is in the first position.

20. The TMOV device of claim 18, wherein the first end of the first terminal comprises a protrusion operable to engage a body of the slider.
